(19) United States
(12) Patent Application Publication
(10) Pub. No.: US 2013/0312399 A1
(43) Pub. Date: Nov. 28, 2013

(54) SYSTEM FOR DRIVING WORKING MACHINE

(71) Applicant: HITACHI CONSTRUCTION MACHINERY CO., LTD., Tokyo (JP)

(72) Inventors: Kenji HIRAKU, Kasumigaura-shi (JP); Kazuo FUJISHIMA, Tsuchiura-shi (JP)

(73) Assignee: HITACHI CONSTRUCTION MACHINERY CO., LTD., Tokyo (JP)

(21) Appl. No.: 13/900,849

(22) Filed: May 23, 2013

(30) Foreign Application Priority Data
May 28, 2012 (JP) 2012-121335

(51) Int. Cl. F15B 15/18

(52) U.S. Cl. CPC F15B 15/18
USPC 60/422

(57) ABSTRACT

The present invention provides a system for driving a working machine, while the system achieves high energy saving, the system improving installability by downsizing hydraulic pumps and motors, and having extensibility enabling an attachment to be easily added. A system for driving a working machine according to the invention includes: a plurality of hydraulic closed circuits that connect hydraulic pumps to hydraulic actuators in a closed circuit manner; hydraulic open circuit that connects a hydraulic pump to hydraulic actuators in an open circuit manner; first assist circuits that connect between the hydraulic closed circuits so as to cause a hydraulic fluid to be mutually supplied between the hydraulic closed circuits; and second assist circuits that connect the hydraulic closed circuits to the hydraulic open circuit so as to cause the hydraulic fluid to be supplied from the hydraulic closed circuits to the hydraulic open circuit.

### BACKGROUND OF THE INVENTION

1. Field of the Invention

The present invention relates to a system for driving a working machine and more particularly to a system for driving a working machine using a hydraulic closed circuit for causing a hydraulic pump to directly drive a hydraulic actuator.

2. Description of the Related Art

In recent years, energy saving has become an important issue for development of construction machines such as hydraulic excavators and wheel loaders. To provide energy-saving construction machines, it is required to save energy consumed by hydraulic systems therefor. The idea under consideration for saving energy consumed by the hydraulic system is the application of a hydraulic closed system in which a hydraulic pump and a hydraulic actuator are connected to each other in a closed circuit manner to cause the hydraulic pump to directly drive the hydraulic actuator. In the case of the hydraulic closed circuit, there is no pressure loss caused by a control valve and no loss of a hydraulic fluid because the hydraulic pump delivers the hydraulic fluid with only a necessary amount. The hydraulic system to which such a hydraulic closed circuit is applied is disclosed in JP-57-54635-A and JP-2004-190845-A.

JP-57-54635-A discloses a configuration in which a plurality of hydraulic actuators are connected to a plurality of hydraulic pumps through a plurality of solenoid control valves in a closed circuit manner, and the connections between the hydraulic pumps and the hydraulic actuators are switched by controlling the solenoid control valves depending on an operational amount of an operation lever. In this configuration, energy saving is achieved by the closed circuits, and at the same time, the number of hydraulic pumps to be installed is reduced by causing a small number of hydraulic pumps to drive a large number of actuators, allowing the installability to be improved.

In addition, JP-2004-190845-A discloses a configuration in which hydraulic pumps and motors that drive three actuators of a boom, stick, and bucket of a hydraulic excavator are provided, and an assist circuit that causes a hydraulic fluid to be mutually supplied between hydraulic circuits is arranged. In this configuration, energy saving is achieved by a closed circuit, and at the same time, the hydraulic pumps and the motors can be downsized by reducing demanded delivery rates of the hydraulic pumps, allowing the installability to be improved.

### SUMMARY OF THE INVENTION

From the perspective of energy saving, it would be desired that a possible number of actuators be arranged in closed circuits. If all actuators were arranged in closed circuits on a working machine that simultaneously operates multiple actuators, however, it would be necessary to arrange hydraulic pumps and motors by the number of units of the actuators that are simultaneously operated. In addition, a single hydraulic pump needs to support the maximum output of the actuators. Thus, the hydraulic pumps and the motors are large in size, which leads to problems with installability and cost. Furthermore, if an actuator that is frequently operated simultaneously with an existing actuator is to be added, speed control cannot be executed on an individual basis by controlling fluid delivery rates of the pumps, which leads to a problem that extensibility deteriorates. Since, among other things, a hydraulic excavator, needs easy addition of an attachment such as a breaker, the deterioration in extensibility is disadvantageous.

In a hydraulic circuit described in JP-57-54635-A, since all the actuators are arranged in the closed circuits, high energy saving is achieved. In addition, since the circuit is configured so that a few hydraulic pumps can drive the large number of actuators, the hydraulic pumps and the motors can be downsized, and thus the installability is excellent. A single hydraulic pump, however, cannot individually control the speeds of multiple actuators, and the number of simultaneously operable actuators is limited to that of hydraulic pumps. Thus, the extensibility is deteriorated.

On the other hand, the assist circuit is arranged in a hydraulic circuit described in JP-2004-190845-A. Thus, the hydraulic pumps and the motors can be each downsized, which leads to excellent installability. In addition, there is no problem with extensibility because an open circuit is arranged. Since only the boom as an actuator is arranged in the closed circuit, however, an effect of energy saving is not sufficient.

An object of the invention is to provide a system for driving a working machine, while the system achieves high energy saving, the system improving installability by downsizing hydraulic pumps and motors, and having extensibility enabling an attachment to be easily added.

(1) In order to accomplish the aforementioned object, according to the invention, a system for driving a working machine includes a plurality of hydraulic closed circuits that connect hydraulic pumps to hydraulic actuators in a closed circuit manner; at least one hydraulic open circuit that connects a hydraulic pump to at least one hydraulic actuator through a control valve in an open circuit manner; a plurality of first assist circuits that connect between the plurality of hydraulic closed circuits so as to cause a hydraulic fluid to be mutually supplied between the plurality of hydraulic closed circuits; and at least one second assist circuit that connects at least one of the plurality of hydraulic closed circuits to the hydraulic open circuit so as to cause the hydraulic fluid to be supplied from at least one of the plurality of hydraulic closed circuits to the hydraulic open circuit.

Since the plurality of hydraulic actuators are driven by the hydraulic closed circuits made up in a closed circuit manner in the configuration described in item (1), there is no pressure loss caused by the control valve and no loss of a delivered hydraulic fluid, the amount of power to be consumed can be suppressed, and energy can be regenerated upon braking. Thus, high energy saving can be achieved.

In addition, the hydraulic fluid can be mutually supplied between the hydraulic closed circuits and supplied from at least one of the hydraulic closed circuits to the hydraulic open circuit. Thus, the hydraulic pumps can be downsized while ensuring necessary speeds of the actuators, and installability can be improved.

Furthermore, since the hydraulic open circuit made up in an open circuit manner is arranged, an attachment can be easily added through a control valve, and extensibility necessary for the working machine can be ensured.

(2) In order to accomplish the aforementioned object, according to the invention, a system for driving a working machine includes a plurality of hydraulic closed circuits that connect hydraulic pumps to hydraulic actuators in a closed circuit manner; at least one fixed pressure source system circuit that includes a hydraulic pump, a common high-pressure line connected to the hydraulic pump and maintaining pressure at a fixed value by receiving the hydraulic fluid delivered from the hydraulic pump, a common low-pressure line connected to a tank, an accumulator connected to the common high-pressure line, and at least one variable displacement hydraulic pump motor connected between the common high-pressure line and the common low-pressure line; a plurality of first assist circuits that connect between the plurality of hydraulic closed circuits so as to cause a hydraulic fluid to be mutually supplied between the plurality of hydraulic closed circuits; and at least one second assist circuit that connects at least one of the plurality of hydraulic closed circuits to the fixed pressure source system circuit so as to cause the hydraulic fluid to be supplied from at least one of the plurality of hydraulic closed circuits to the fixed pressure source system circuit.

Since the plurality of hydraulic actuators are driven by the hydraulic closed circuits made up in a closed circuit manner in the configuration described in item (2), there is no pressure loss caused by the control valve and no loss of a delivered hydraulic fluid, the amount of power to be consumed can be suppressed, and energy can be regenerated upon braking. Thus, high energy saving can be achieved. In the fixed pressure source system circuit, there is no pressure loss caused by the control valve, compared with the configuration including the hydraulic open circuit, and braking energy can be regenerated upon deceleration of the hydraulic actuators. Thus, significantly high energy saving can be achieved.

In addition, since the hydraulic fluid can be mutually supplied between the hydraulic closed circuits and supplied from at least one of the hydraulic closed circuits to the fixed pressure source system circuit, the hydraulic pumps can be downsized while ensuring necessary speeds of the actuators, and thus the installability can be improved.

Since an attachment can be easily added only by adding a variable displacement hydraulic pump motor in the fixed pressure source system circuit, extensibility necessary for the working machine can be ensured.

(3) In items (1) or (2), the working machine is a hydraulic excavator, and the hydraulic actuators that are connected to the hydraulic pumps in the closed circuit manner in the plurality of hydraulic closed circuits are at least a boom cylinder and an arm cylinder.

Energy to be consumed by the boom cylinder and the arm cylinder among the actuators of the hydraulic excavator is large. If the boom cylinder and the arm cylinder are arranged in the hydraulic open circuit, energy to be lost due to throttle resistance is large. Thus, high energy saving can be efficiently achieved by causing the hydraulic closed circuits to drive the boom cylinder and the arm cylinder.

If the boom cylinder is arranged in the hydraulic open circuit, large potential energy is lost upon lowering of a boom. The boom cylinder, however, is driven by the hydraulic closed circuit made up in a closed circuit manner, and whereby potential energy can be regenerated.

If the arm cylinder is arranged in the hydraulic open circuit, an increase in the speed upon application of a negative load caused by the weight of the arm cylinder is suppressed by a throttle on a meter-out side of a control valve, or by braking effect from a counter balance valve. This causes resistance upon the driving, and whereby energy to be consumed is increased. The arm cylinder, however, is driven by the hydraulic closed circuit made up in such a closed circuit manner, and whereby the hydraulic pumps act as regeneration brakes and throttle resistance is not required. Thus, energy to be consumed for the driving can be significantly reduced.

(4) In item (2), the working machine is a hydraulic excavator, and the variable displacement hydraulic pump motor that is connected between the common high-pressure line and the common low-pressure line in the fixed pressure source system circuit is a swing hydraulic motor or a travel hydraulic motor.

If a hydraulic actuator that is driven by the fixed pressure source system circuit is a rotary actuator for swing or traveling, torque of the variable displacement hydraulic pump motor can be used without a change. Thus, it is sufficient if a hydraulic motor that is normally used is replaced with the variable displacement hydraulic pump motor, and the control valve may not be necessary. Thus, installability is excellent.

According to the invention, the amount of power to be consumed is suppressed by causing the hydraulic closed circuits made up in a closed circuit manner to drive the plurality of actuators, and thus high energy saving can be achieved. In addition, the hydraulic fluid can be mutually supplied between the hydraulic closed circuits and supplied from at least one of the hydraulic closed circuits to the hydraulic open circuit. Thus, the hydraulic pumps can be downsized while ensuring necessary speeds and outputs of the actuators, and the installability can be improved. Furthermore, since the hydraulic open circuit made up in an open circuit manner is arranged, an attachment can be easily added, and extensibility necessary for the working machine can be ensured.

### BRIEF DESCRIPTION OF THE DRAWINGS

FIG. 1 is a diagram illustrating an overall configuration of a system for driving a working machine according to a first embodiment.

FIG. 2 is a diagram illustrating an overall configuration of a system for driving a working machine according to a second embodiment.

FIG. 3 is a diagram illustrating an overall configuration of a system for driving a working machine according to a third embodiment.

FIG. 4 is a diagram illustrating an appearance of a hydraulic excavator that is an example of a working machine provided with a drive system according to any of the embodiments of the invention.

FIG. 5 is a diagram illustrating a table indicating a part of functions of a controller of the system for driving a working machine according to the first embodiment.

### DESCRIPTION OF THE PREFERRED EMBODIMENTS

Hereinafter, embodiments of the invention are described with reference to the accompanying drawings.

### First Embodiment

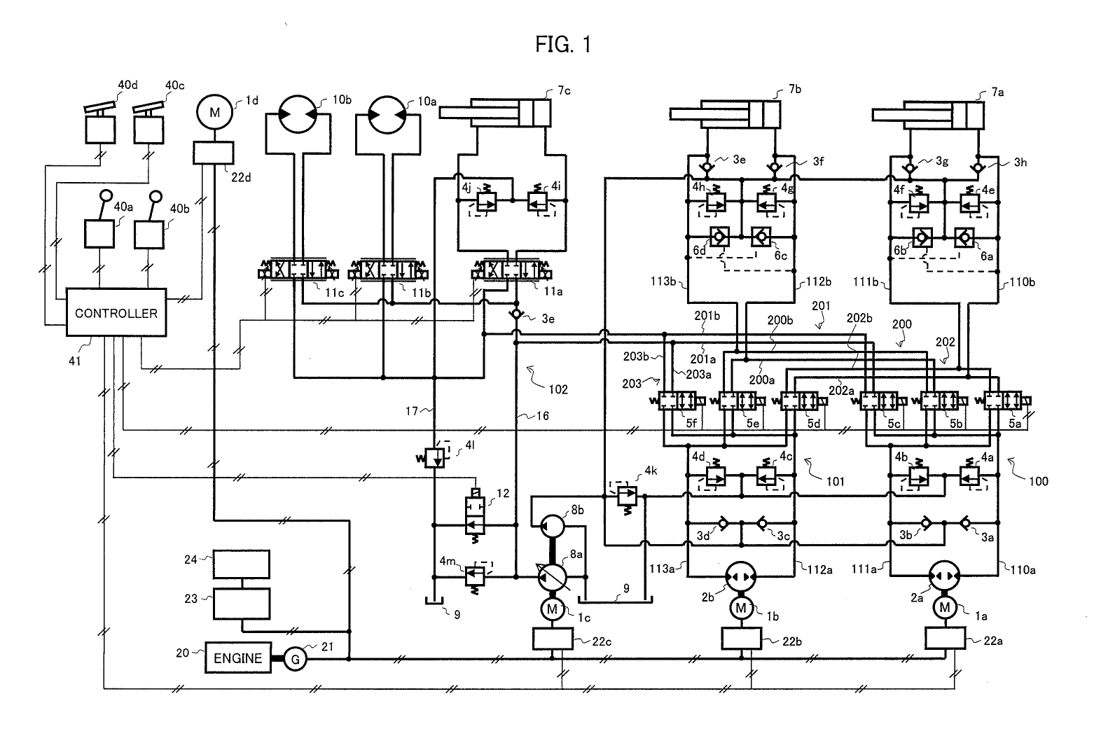

First, the first embodiment of the invention is described with reference to FIGS. 1, 4, and 5.

Referring to FIG. 1, a system for driving a working machine according to the first embodiment includes hydraulic actuators 7a, 7b, 7c, 10a, and 10b, hydraulic closed circuits 100 and 101, a hydraulic open circuit 102, first assist circuits 200 and 202, and second assist circuits 201 and 203.

The hydraulic closed circuit 100 includes a motor 1a, a bidirectional delivery type hydraulic pump motor 2a, check valves 3a, 3b, 3g, and 3h, relief valves 4a, 4b, 4e, and 4f, and pilot check valves 6a and 6b. The motor 1a is directly connected to the bidirectional delivery type hydraulic pump motor 2a. The bidirectional delivery type hydraulic pump motor 2a is connected to a boom cylinder 7a through closed circuit lines 110a, 110b, 111a, and 111b and a solenoid control valve 5a in a closed circuit manner. The motor 1a normally and reversely rotates a bidirectional delivery type hydraulic pump 2a and thereby causes the bidirectional delivery type hydraulic pump 2a to suck and deliver a hydraulic fluid and causes the boom cylinder 7a to reciprocate. Specifically, a delivery rate and delivery direction of the hydraulic pump 2a are controlled by controlling a speed and direction of rotation of the motor 1a, and whereby a driving speed and driving direction of the boom cylinder 7a are controlled. When pressure within the circuit is reduced, the check valves 3a and 3b cause the hydraulic fluid delivered from a charge pump 8b to be sucked into the circuit and prevent cavitation in the circuit. When delivery pressure of the hydraulic pump 2a is equal to or higher than a set pressure value, the relief valves 4a and 4b cause the hydraulic fluid to be discharged from the circuit and prevent the pump and the lines from being damaged. The relief valves 4e and 4f are arranged in order to protect a hydraulic circuit located on the downstream side of the solenoid control valve 5a. The pilot check valves 6a and 6b deliver the hydraulic fluid to a low-pressure line or suck the hydraulic fluid from the low-pressure line in order to eliminate a difference, caused by the reciprocation of the boom cylinder 7a (serving as a single rod cylinder), between the amounts of the hydraulic fluids.

The hydraulic closed circuit 101 includes a motor 1b, a bidirectional delivery type hydraulic pump motor 2b, check valves 3c, 3d, 3e, and 3f, relief valves 4c, 4d, 4g, and 4h, and pilot check valves 6c and 6d. The motor 1b is directly connected to the bidirectional delivery type hydraulic pump motor 2b. The bidirectional delivery type hydraulic pump motor 2b is connected to an arm cylinder 7b through closed circuit lines 112a, 112b, 113a and 113b and a solenoid control valve 5e in a closed circuit manner. The motor 1b normally and reversely rotates a bidirectional delivery type hydraulic pump 2b and thereby causes the bidirectional delivery type hydraulic pump 2b to suck and deliver the hydraulic fluid and causes the arm cylinder 7b to reciprocate. Specifically, a delivery rate and delivery direction of the hydraulic pump 2b are controlled by controlling a speed and direction of rotation of the motor 1b, and whereby a driving speed and driving direction of the arm cylinder 7b are controlled. When pressure within the circuit is reduced, the check valves 3c and 3d cause the hydraulic fluid delivered from the charge pump 8b to be sucked into the circuit and prevent cavitation in the circuit. When delivery pressure of the hydraulic pump 2b is equal to or higher than a set pressure value, the relief valves 4c and 4d cause the hydraulic fluid to be discharged from the circuit and prevent the pump and the lines from being damaged. The relief valves 4g and 4h are arranged in order to protect a hydraulic circuit located on the downstream side of the solenoid control valve 5e. The pilot check valves 6c and 6d deliver the hydraulic fluid to a low-pressure line or suck the hydraulic fluid from the low-pressure line in order to eliminate a difference, caused by the reciprocation of the arm cylinder 7b (serving as a single rod cylinder), between the amounts of the hydraulic fluids.

The hydraulic open circuit 102 includes a motor 1c, a hydraulic pump 8a, a charge pump 8b, a check valve 3e, control valves 11a, 11b, and 11c, high-pressure relief valves 4i, 4j, and 4m, a low-pressure relief valve 4l, and a bypass valve 12. The motor 1c is directly connected to the hydraulic pump 8a and the charge pump 8b. The hydraulic pump 8a is connected to a bucket cylinder 7c, and right and left travel hydraulic motors 10a and 10b through a hydraulic fluid supply line 16 and the control valves 11a to 11c. The hydraulic fluid delivered from the hydraulic pump 8a is supplied to the hydraulic actuators 7c, 10a, and 10b through the hydraulic fluid supply line 16 and the control valves 11a to 11c. Returning sides of the control valves 11a to 11c are connected to a tank 9 through a low-pressure line 17 and the low-pressure relief valve 4l. The hydraulic fluid returned from the hydraulic actuators 7c, 10a, and 10b is returned to the tank 9 through the control valves 11a to 11c and the low-pressure line 17. As described above, the hydraulic open circuit 102 is made up in an open circuit manner that returns the hydraulic fluid returned from the hydraulic actuators 7c, 10a, and 10b to the tank 9. A driving direction and speed of the bucket cylinder 7c are controlled by the control valve 11a. Driving directions and speeds of the right and left travel hydraulic motors 10a and 10b are controlled by the control valves 11b and 11c, respectively. When the pressure within the circuit is reduced, the check valve 3e causes the hydraulic fluid delivered from the charge pump 8b to be sucked into the circuit and prevents cavitation in the circuit. The high-pressure relief valves 4i and 4j protects a hydraulic circuit located on the downstream side of the control valve 11a. When delivery pressure of the hydraulic pump 8a is equal to or higher than a set pressure value, the high-pressure relief valve 4m causes the hydraulic fluid to be discharged from the circuit and prevents the pumps and the lines from being damaged. When the solenoid control valves 5c and 5f are in an ON state and the charge pump 8b is directly connected to the tank 9 through the check valves 3b and 3d, the low-pressure relief valve 4l prevents a reduction in charge pressure of the charge pump 8b and enables a part of the hydraulic fluid returned from the hydraulic actuators 7c, 10a, and 10b of the hydraulic open circuit 102 to return to sucking sides of the hydraulic pumps 2a and 2b. The bypass valve 12 has a function of causing the hydraulic fluid delivered from the hydraulic pump 8a to return to the tank 9 and unloading the delivery pressure when the hydraulic actuators 7c, 10a, and 10b are not driven.

Although the single hydraulic open circuit is arranged in the present embodiment, the number of hydraulic open circuits is not limited to 1 and may be 2 or more.

The first assist circuit 200 includes hydraulic lines 200a and 200b and a solenoid control valve 5b. The hydraulic lines 200a and 200b connect the hydraulic closed circuits 100 and 101 to each other. The solenoid control valve 5b opens and closes the hydraulic lines 200a and 200b.

The second assist circuit 201 includes hydraulic lines 201a and 201b and a solenoid control valve 5c. The hydraulic lines 201a and 201b connect the hydraulic closed circuit 100 to the hydraulic open circuit 102. The solenoid control valve 5c opens and closes the hydraulic lines 201a and 201b.

The first assist circuit 202 includes hydraulic lines 202a and 202b and a solenoid control valve 5d. The hydraulic lines 202a and 202b connect the hydraulic closed circuits 101 and 100 to each other. The solenoid control valve 5d opens and closes the hydraulic lines 202a and 202b.

The second assist circuit 203 includes hydraulic lines 203a and 203b and a solenoid control valve 5f. The hydraulic lines 203a and 203b connect the hydraulic closed circuit 101 to the hydraulic open circuit 102. The solenoid control valve 5f opens and closes the hydraulic lines 203a and 203b.

When the solenoid control valves 5b and 5c are turned on (or opened), the solenoid control valve 5a is turned off (or closed) so as to supply (or assist supply of) a hydraulic fluid from the hydraulic closed circuit 100 to the hydraulic closed circuit 101 and the hydraulic open circuit 102. Similarly, when the solenoid control valves 5d and 5f are turned on (or opened), the solenoid control valve 5e is turned off (or closed) so as to supply (or assist supply of) the hydraulic fluid from the hydraulic closed circuit 101 to the hydraulic closed circuit 100 and the hydraulic open circuit 102.

Although the two second assist circuits are arranged in the present embodiment, the number of second assist circuits is not limited and may be 1.

The drive system according to the present embodiment has a swing motor 1d for turning an upper swing structure of a hydraulic excavator.

The drive system according to the present embodiment includes an engine 20, a power generator 21, inverters 22a to 22d, a converter 23, a battery 24, and a controller 41 as an engine and control system. The power generator 21 is connected to the engine 20. The inverters 22a to 22d are connected to the power generator 21. The converter 23 is connected to the power generator 21. The battery 24 is connected to the converter 23. The engine 20 drives the power generator 21. Power generated by the power generator 21 is supplied to the motors 1a to 1d through the inverters 22a to 22d, and part of the power is stored in the battery 24 through the converter 23.

The drive system according to the present embodiment includes control lever type operating devices 40a and 40b and control pedal type operating devices 40c and 40d as an operation system. The operating devices 40a and 40b are connected to the controller 41. An up and down operation of the operating device 40a corresponds to an operation of the swing motor 1d. A left and right operation of the operating device 40a corresponds to an operation of the arm cylinder 7b. An up and down operation of the operating device 40b corresponds to an operation of the boom cylinder 7a. A left and right operation of the operating device 40b corresponds to an operation of the bucket cylinder 7c. An operation of the operating device 40c corresponds to an operation of the right travel hydraulic motor 10a. An operation of the operating device 40d corresponds to an operation of the left travel hydraulic motor 10b. Note that correspondence relationships between operational directions of the operating devices 40a and 40b and operations of the hydraulic actuators may be based on another scheme.

The controller 41 executes arithmetic processing on operation signals received from the operating devices 40a to 40d, outputs control signals after the arithmetic processing to the solenoid control valves 5a to 5f, the control valves 11a to 11c, the bypass valve 12, and the inverters 22a to 22d, and controls these components.

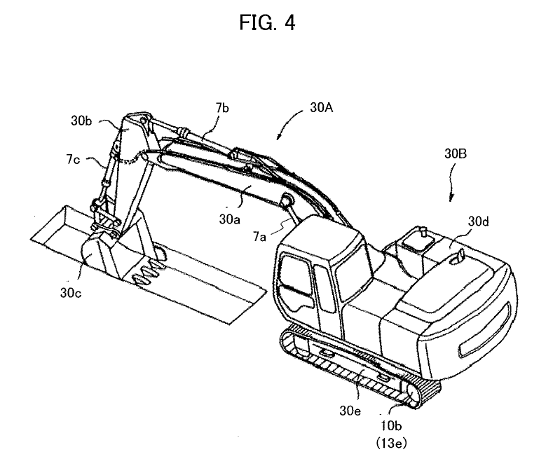

FIG. 4 illustrates an appearance of a hydraulic excavator that is an example of a working machine provided with the drive system according to the present embodiment. In FIG. 4, parts that are the same as those illustrated in FIG. 1 are indicated by the same reference symbols. The hydraulic excavator has an upper swing structure 30d, a lower travel structure 30e, and a front device 30A. The lower travel structure 30e is moved by the right and left travel hydraulic motors 10a and 10b (only one travel hydraulic motor is illustrated). The upper swing structure 30d is swung on the lower travel structure 30e by the swing motor 1d (refer to FIG. 1). The front device 30A has a multijoint structure including a boom 30a, an arm 30b, and a bucket 30c. The boom 30, the arm 30b, and the bucket 30c are rotationally driven in a vertical plane by the boom cylinder 7a, the arm cylinder 7b, and the bucket cylinder 7c, respectively.

The driving of the right and left travel hydraulic motors 10a and 10b (the one travel hydraulic motor is illustrated) is controlled by operating the control valves 11b and 11c (refer to FIG. 1) on the basis of operational amounts of the operating devices 40c and 40d (refer to FIG. 1). The driving of the swing structure 30d is controlled by operating the inverter 22d (refer to FIG. 1) and the swing motor 1d (refer to FIG. 1) on the basis of an operational amount of the operating device 40a (refer to FIG. 1) in a vertical direction. The driving of the boom cylinder 7a is controlled by operating the inverter 22a (refer to FIG. 1) and the motor 1a (refer to FIG. 1) on the basis of an operational amount of the operating device 40b (refer to FIG. 1) in the vertical direction. The driving of the arm cylinder 7b is controlled by operating the inverter 22b (refer to FIG. 1) and the motor 1b (refer to FIG. 1) on the basis of an operational amount of the operating device 40a (refer to FIG. 1) in a left-right direction. The driving of the bucket cylinder 7c is controlled by operating the control valve 11a (refer to FIG. 1) on the basis of an operational amount of the operating device 40b (refer to FIG. 1) in the left-right direction. The amount of the hydraulic fluid to be delivered from the hydraulic pump 8a (refer to FIG. 1) is controlled by operating the inverter 22c (refer to FIG. 1) and the motor 1c (refer to FIG. 1) on the basis of an operational amount of the operating device 40a (refer to FIG. 1) in the left-right direction and operational amounts of the operating devices 40c and 40d (refer to FIG. 1).

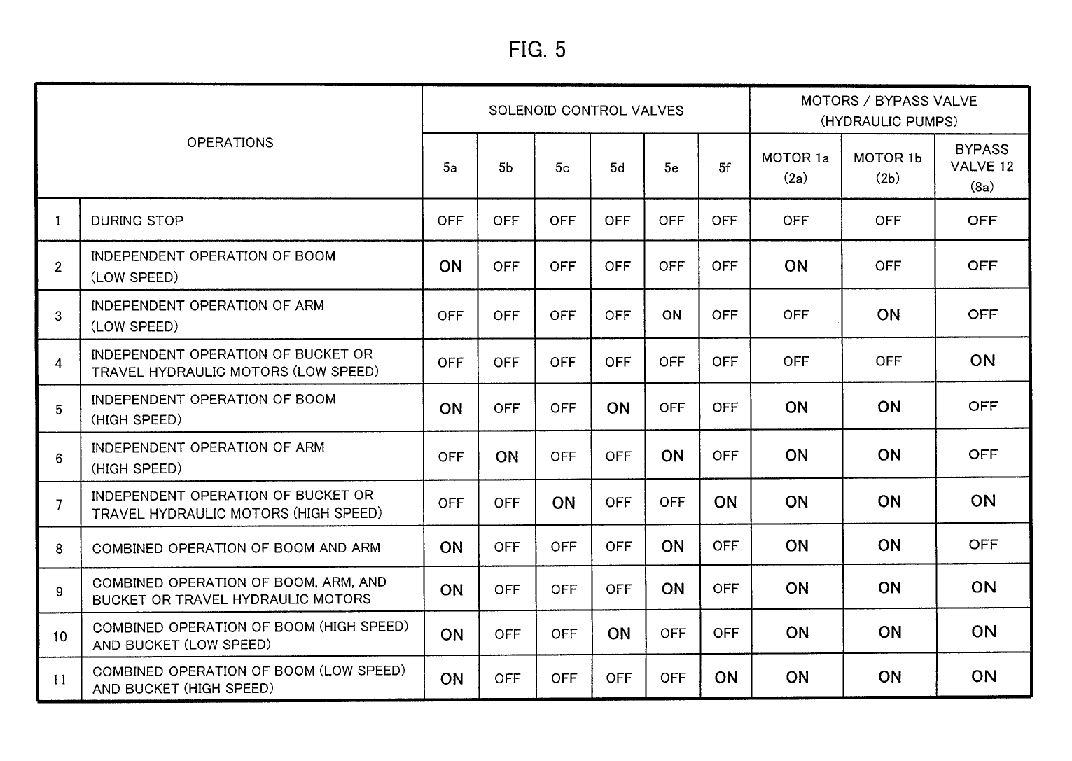

Operations of the drive system with the aforementioned configuration are described with reference to FIG. 5. FIG. 5 illustrates a part of functions of the controller 41.

First, the case where the boom or the arm is independently operated is described below.

During stop of the boom 30a and the arm 30b, the operating devices 40a and 40b are not operated and are in a neutral state. In this case, the solenoid control valves 5a, 5b, 5d, and 5e are in an OFF state (or all closed), the motors 1a and 1b are not operated, and the hydraulic fluid is not supplied from the hydraulic pumps 2a and 2b (in operation 1). In this case, the boom cylinder 7a and arm cylinder 7b are prevented from falling due to their own weights.

To independently drive the boom 30a at a low speed, the operating device 40b is half operated in a front-back direction, for example. In this case, the solenoid control valve 5a is turned on, the hydraulic pump 2a is connected to the boom cylinder 7a, the motor 1a is operated, and whereby the hydraulic fluid is supplied from the hydraulic pump 2a to the boom cylinder 7a (in operation 2).

To independently drive the arm 30b at a low speed, the operating device 40a is half operated in the left-right direction, for example. In this case, the solenoid control valve 5e is turned on, the hydraulic pump 2b is connected to the arm cylinder 7b, the motor 1b is operated, and whereby the hydraulic fluid is supplied from the hydraulic pump 2b to the arm cylinder 7b (in operation 3).

To independently drive the boom 30a at a high speed, the operating device 40b is fully operated in the front-back direction. In this case, the solenoid control valves 5a and 5d are turned on, the two hydraulic pumps 2a and 2b are connected to the boom cylinder 7a, the motors 1a and 1b are operated, and whereby the hydraulic fluid is supplied from the two hydraulic pumps 2a and 2b to the boom cylinder 7a (in operation 5).

To independently drive the arm 30b at a high speed, the operating device 40a is fully operated in the left-right direction. In this case, the solenoid control valves 5e and 5b are turned on, the two hydraulic pumps 2a and 2b are connected to the arm cylinder 7b, the motors 1a and 1b are operated, and whereby the hydraulic fluid is supplied from the two hydraulic pumps 2a and 2b to the arm cylinder 7b (in operation 6).

Next, the case where the bucket 30c or the left and right travel hydraulic motors 10a and 10b is or are independently operated is described.

During stop of the bucket 30c and the left and right travel hydraulic motors 10a and 10b, the operating device 40b is not operated and is in the neutral state, and the operating devices 40c and 40d are not operated. In this case, the bypass valve 12 is in an OFF state (or open), the hydraulic pump 8a is unloaded. Specifically, the hydraulic fluid delivered from the hydraulic pump 8a is returned to the tank 9 through the bypass valve 12. In this case, the motor 1c rotates at the minimum rotational speed, and power consumed by the motor 1c is suppressed to a small value (in operation 1). Since the motor 1c rotates at the minimum rotational speed and the hydraulic pump 8a delivers the fluid with the minimum amount, a response upon start-up is improved. In this case, the motor 1c may be stopped, and whereby the power consumed by the motor 1c can be further suppressed.

To independently drive the bucket 30c or the left and right travel hydraulic motors 10a and 10b at a low speed, the operating device 40b is half operated in the left-right direction or the operating devices 40c and 40d are half operated, for example. In this case, the bypass valve 12 is turned on (or closed), the delivery pressure of the hydraulic pump 8a is increased, the control valve 11a or the control valves 11b and 11c are switched on the basis of an operational amount of the operating device 40b in the left-right direction or operational amounts of the operating devices 40c and 40d, the rotational speed of the motor 1c is increased, the delivery rate of the hydraulic pump 8a is increased, and whereby the hydraulic fluid is supplied to the bucket cylinder 7c or the right and left travel hydraulic motors 10a and 10b (in operation 4).

To independently drive the bucket 30c or the left and right travel hydraulic motors 10a and 10b at a high speed, the operating device 40b is fully operated in the left-right direction or the operating devices 40c and 40d are fully operated. In this case, the bypass valve 12 is turned on, and the delivery pressure of the hydraulic pump 8a is increased. In addition, at least one of the solenoid control valves 5c and 5f is turned on (both solenoid control valves 5c and 5f are turned on in the example illustrated in FIG. 5), and at least one of the hydraulic pumps 2a and 2b is connected to the hydraulic open circuit 102 (both hydraulic pumps 2a and 2b are connected to the hydraulic open circuit 102 in the example illustrated in FIG. 5). Furthermore, the control valve 11a or the control valves 11b and 11c are switched on the basis of an operational amount of the operating device 40b in the left-right direction or operational amounts of the operating devices 40c and 40d, and at least one of the motors 1a and 1b is operated (both motors 1a and 1b are operated in the example illustrated in FIG. 5). Thus, the hydraulic fluid delivered from the hydraulic pump 8a and the hydraulic fluid delivered from at least one of the hydraulic pumps 2a and 2b join together (hydraulic fluids delivered from up to three hydraulic pumps join together) and are supplied to the bucket cylinder 7c or the right and left travel hydraulic motors 10a and 10b (in operation 7).

Lastly, the case of a combined operation of the boom 30a, the arm 30b and the bucket 30c or traveling is described.

To simultaneously drive the boom 30a and the arm 30b, the operating device 40b is operated in the front-back direction and the operating device 40a is operated in the left-right direction. In this case, the solenoid control valves 5a and 5e are turned on, the hydraulic pumps 2a and 2b are connected to the boom cylinder 7a and the arm cylinder 7b, respectively, the motors 1a and 1b are operated, and whereby the hydraulic fluid is supplied from the hydraulic pumps 2a and 2b to the boom cylinder 7a and the arm cylinder 7b, respectively (in operation 8).

To simultaneously drive the boom 30a, the arm 30b, and the bucket 30c or the right and left travel hydraulic motors 10a and 10b, the operating device 40b is operated in the front-back direction, the operating device 40a is operated in the left-right direction, and the operating device 40b is operated in the left-right direction or the operating devices 40c and 40d are operated. In this case, the solenoid control valves 5a and 5e are turned on, the bypass valve 12 is turned on (or closed), the motors 1a to 1c are operated, and whereby the hydraulic fluid is supplied from the hydraulic pumps 2a and 2b to the boom cylinder 7a and the arm cylinder 7b, respectively, and the hydraulic fluid is supplied from the hydraulic pump 8a to the bucket cylinder 7c or the right and left travel hydraulic motors 10a and 10b (in operation 9). In this case, the independencies of the hydraulic actuators are maintained, and controllability is ensured.

To simultaneously drive the boom 30a and the bucket 30c, the operating device 40b is operated in the front-back direction, and the operating device 40b is operated in the left-right direction. In this case, the solenoid control valve 5a is turned on, the bypass valve 12 is turned on, the motors 1a and 1c are operated, and whereby the hydraulic fluid is supplied from the hydraulic pump 2a to the boom cylinder 7a and supplied from the hydraulic pump 8a to the bucket cylinder 7c. In this case, the hydraulic pump 2b is operated as follows.

To drive the boom 30a at a high speed and drive the bucket 30c simultaneously with the driving of the boom 30a, the operating device 40b is fully operated in the front-back direction and half operated in the left-right direction, for example. In this case, the solenoid control valves 5a and 5d are turned on, the bypass valve 12 is turned on, the motors 1a and 1b are operated, the hydraulic fluids delivered from the hydraulic pumps 2a and 2b join together and are supplied to the boom cylinder 7a, and the hydraulic fluid is supplied from the hydraulic pump 8a to the bucket cylinder 7c (in operation 10).

To drive the bucket 30c at a high speed and drive the boom 30a simultaneously with the driving of the bucket 30c, the operating device 40b is half operated in the front-back direction and fully operated in the left-right direction, for example. In this case, the solenoid control valves 5a and 5f are turned on, the bypass valve 12 is turned on, the motors 1a and 1b are operated, the hydraulic fluid is supplied from the hydraulic pump 2a to the boom cylinder 7a, and the hydraulic fluids delivered from the hydraulic pumps 8a and 2b join together and are supplied to the bucket cylinder 7c (in operation 11).

According to the present embodiment described above, the following effects can be obtained.

Since the boom 30a and the arm 30b are driven by the hydraulic closed circuits 100 and 101 made up in a closed circuit manner, respectively, there is no pressure loss caused by the control valves and no loss of the hydraulic fluid, and the amount of power to be consumed can be suppressed. In addition, the bidirectional delivery type hydraulic pump motor 2a acts as a motor upon lowering of the boom, and potential energy can be regenerated by driving the motor 1a and thereby generating power. Since the bidirectional delivery type hydraulic pump motor 2a acts as a regeneration brake upon application of a negative load caused by the weight of the arm 30b, energy is not consumed by throttle resistance. Thus, high energy saving can be achieved.

In addition, since the hydraulic fluid can be mutually supplied between the hydraulic closed circuits 100 and 101 and supplied from the hydraulic closed circuits 100 and 101 to the hydraulic open circuit 102, the hydraulic pumps and the motors can be downsized while ensuring necessary speeds of the actuators, and whereby installability is improved.

Furthermore, since the hydraulic open circuit 102 is made up in an open circuit manner, a hydraulic actuator as an attachment can be easily added through a control valve, extensibility that is necessary for the hydraulic excavator can be ensured.

### Second Embodiment

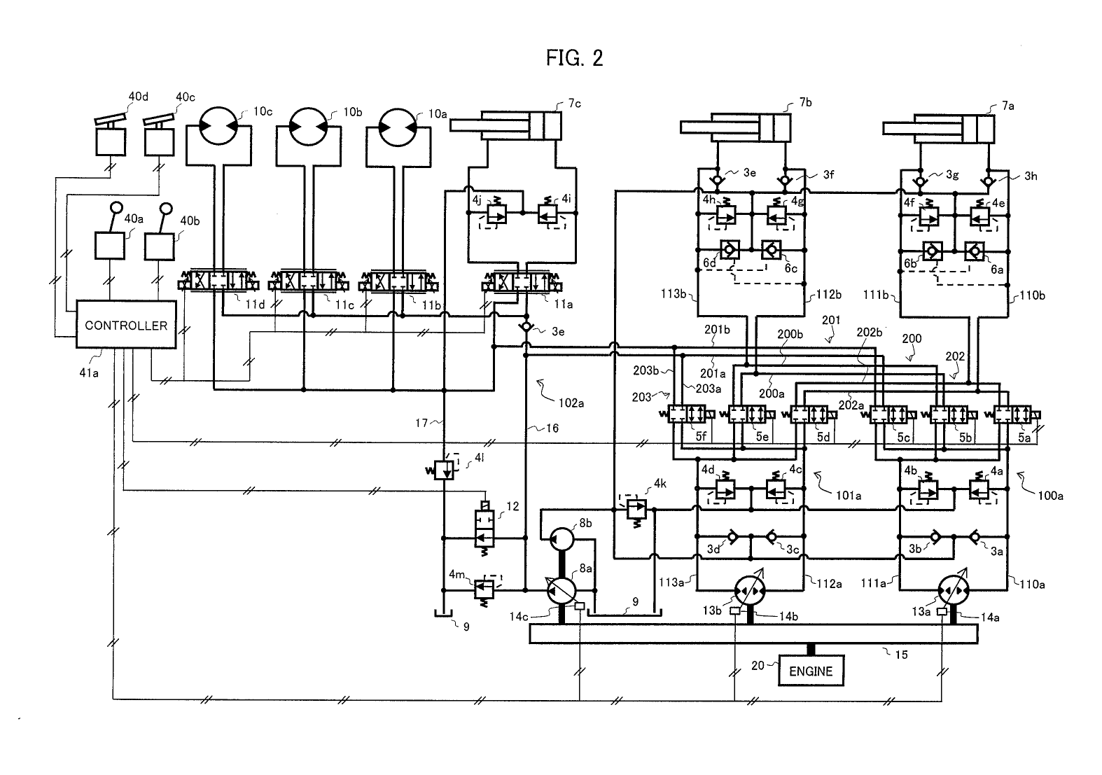

Next, the second embodiment of the invention is described with reference to FIGS. 2 and 4. The second embodiment describes the case where a motor is not used and the configurations of the hydraulic circuits are nearly the same as the first embodiment. In FIGS. 2 and 4, parts that are the same as those illustrated in FIG. 1 are indicated by the same reference symbols, and a description thereof is omitted.

Referring to FIG. 2, a system for driving a working machine according to the second embodiment includes a swing hydraulic motor 10c instead of the swing motor 1d (refer to FIG. 1) according to the first embodiment and includes hydraulic closed circuits 100a and 101a and a hydraulic open circuit 102a instead of the hydraulic closed circuits 100 and 101 (refer to FIG. 1) and the hydraulic open circuit 102 (refer to FIG. 1).

The hydraulic closed circuit 100a includes a bidirectional delivery and variable displacement type hydraulic pump motor 13a instead of the bidirectional delivery type hydraulic pump motor 2a (refer to FIG. 1). The hydraulic closed circuit 101a includes a bidirectional delivery and variable displacement type hydraulic pump motor 13b instead of the bidirectional delivery type hydraulic pump motor 2b (refer to FIG. 1). Hydraulic pumps 13a and 13b and the hydraulic pump 8a of the hydraulic open circuit 102a have regulators 14a, 14b, and 14c, respectively. The regulators 14a, 14b, and 14c control tilting amounts (pump capacity) and tilting directions (delivery directions of the hydraulic fluids) of the hydraulic pumps 13a, 13b, and 8a on the basis of operational amounts (demanded fluid amounts) and operation directions of the operating devices 40a to 40d. The amounts of the hydraulic fluids to be delivered from the hydraulic pumps 13a and 13b and the directions of the delivery of the hydraulic fluids are controlled by controlling the tilting amounts and tilting directions of the hydraulic pumps 13a and 13b, and whereby driving speeds and driving directions of the hydraulic actuators 7a and 7b are controlled. The hydraulic open circuit 102a has a control valve 11d. The hydraulic pump 8a is connected to the swing hydraulic motor 10c through the control valve 11d. The parts that are related to the control valve 11d of the hydraulic open circuit 102a are included in a hydraulic open circuit in which the hydraulic fluid is returned from the swing hydraulic motor 10c through the control valve 11d to the tank 9. The driving direction and speed of the swing hydraulic motor 10c are controlled by the control valve 11d.

The drive system according to the second embodiment includes a controller 41a and a power transfer device 15 that is connected to the engine 20 and distributes power of the engine 20 to the hydraulic pumps 13a, 13b, and 8a and the charge pump 8b as an engine and control system.

The controller 41a executes arithmetic processing on operation signals received from the operating devices 40a to 40d, outputs control signals after the arithmetic processing to the solenoid control valves 5a to 5f, the control valves 11a to 11d, the bypass valve 12, and the regulators 14a to 14c of the hydraulic pumps 13a, 13b, and 8a, and controls these components.

According to the second embodiment described above, high energy saving, installability, and high extensibility, which are the same as or close to the first embodiment, can be obtained without using a motor.

In the second embodiment, the swing hydraulic motor 10c is driven by the hydraulic open circuit made up in an open circuit manner. Another bidirectional delivery and variable displacement type hydraulic pump motor may be added and driven by the hydraulic closed circuit made up in a closed circuit manner. In this case, large braking energy can be regenerated upon deceleration of the swing hydraulic motor 10c, and whereby higher energy saving can be obtained. Specifically, since load torque is reduced for the engine 20 upon the regeneration of the braking energy, the amount of a fuel to be injected to maintain the revolution of the engine 20 can be reduced, and the amount of the fuel to be consumed can be reduced.

### Third Embodiment

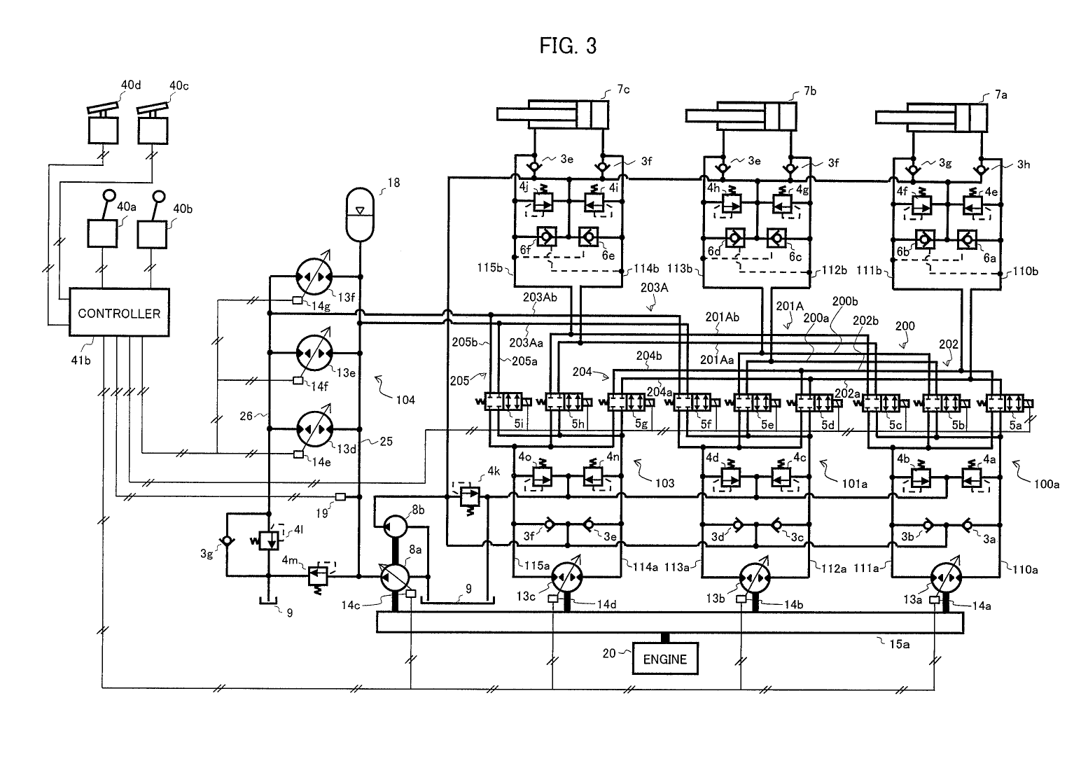

The third embodiment of the invention is described with reference to FIGS. 3 and 4. In the third embodiment, the hydraulic open circuit according to the second embodiment is replaced with a fixed pressure source system circuit (secondary control system circuit), and a hydraulic closed circuit for the bucket cylinder is added. In FIGS. 3 and 4, parts that are the same as those illustrated in FIGS. 1 and 2 are indicated by the same reference numerals and symbols, and a description thereof is omitted.

Referring to FIG. 3, a system for driving a working machine according to the third embodiment includes a variable displacement type right travel hydraulic pump motor 13d, a variable displacement type left travel hydraulic pump motor 13e, and a variable displacement type swing hydraulic pump motor 13f instead of the right and left travel hydraulic motors 10a and 10b (refer to FIG. 2) and the swing hydraulic motor 10c (refer to FIG. 2) and includes a hydraulic closed circuit 103 and a fixed pressure source system circuit 104 instead of the hydraulic open circuit 102a (refer to FIG. 2). The system for driving a working machine according to the third embodiment includes a first assist circuit 201A and a second assist circuit 203A instead of the second assist circuits 201 and 203 (refer to FIG. 2) and further includes a first assist circuit 204 and a second assist circuit 205.

The hydraulic closed circuit 103 includes a bidirectional delivery and variable displacement type hydraulic pump motor 13c, the check valves 3e and 3f, the relief valves 4i, 4j, 4n and 4o, and pilot check valves 6e and 6f. The bidirectional delivery and variable displacement type hydraulic pump motor 13c includes a regulator 14d that controls a tilting amount (pump capacity) and tilting direction (delivery directions of the hydraulic fluids) of a hydraulic pump 13c. The bidirectional delivery and variable displacement type hydraulic pump motor 13c is connected to the bucket cylinder 7c through closed circuit lines 114a, 114b, 115a, and 115b and a solenoid control valve 5h in a closed circuit manner. The amount and direction of the hydraulic fluid to be delivered from the hydraulic pump 13c are controlled by controlling the tilting amount and tilting direction of the hydraulic pump 13c, and whereby the driving speed and driving direction of the bucket cylinder 7c are controlled.

The fixed pressure source system circuit 104 includes the hydraulic pump 8a and the charge pump 8b as hydraulic sources. The engine 20 drives the variable displacement hydraulic pump motors 13a, 13b, and 13c, the hydraulic pump 8a, and the charge pump 8b through a power transfer device 15a.

The first assist circuit 201A includes hydraulic lines 201Aa and 201Ab and a solenoid control valve 5c. The hydraulic lines 201Aa and 201Ab connect the hydraulic closed circuits 100a and 103 to each other. The solenoid control valve 5c opens and closes the hydraulic lines 201Aa and 201Ab.

The second assist circuit 203A includes hydraulic lines 203Aa and 203Ab and a solenoid control valve 5f. The hydraulic lines 203Aa and 203Ab connect the hydraulic closed circuit 101a to the fixed pressure source system circuit 104. The solenoid control valve 5f opens and closes the hydraulic lines 203Aa and 203Ab.

The first assist circuit 204 includes hydraulic lines 204a and 204b and a solenoid control valve 5g. The hydraulic lines 204a and 204b connect the hydraulic closed circuits 103 and 100a to each other. The solenoid control valve 5g opens and closes the hydraulic lines 204a and 204b.

The second assist circuit 205 includes hydraulic lines 205a and 205b and a solenoid control valve 5i. The hydraulic lines 205a and 205b connect the hydraulic closed circuit 103 to the fixed pressure source system circuit 104. The solenoid control valve 5i opens and closes the hydraulic lines 205a and 205b.

When the solenoid control valves 5g and 5i are turned on (or opened), the solenoid control valve 5h is turned off (or closed) so as to supply (or assist of supply of) the hydraulic fluid from the hydraulic closed circuit 103 to the hydraulic closed circuit 100a and the fixed pressure source system circuit 104.

When the solenoid control valves 5a, 5d, and 5g are turned on, the boom cylinder 7a is connected to the three variable displacement hydraulic pump motors 13a, 13b, and 13c and can be driven at a higher speed when necessary. Similarly, when the solenoid control valves 5c and 5h are turned on, the bucket cylinder 7c is connected to the two variable displacement hydraulic pump motors 13a and 13c and can be driven at a high speed when necessary.

Although the two second assist circuits are arranged in the present embodiment, the number of second assist circuits is not limited to 2 and may be 1.

The fixed pressure source system circuit 104 includes a common high-pressure line 25, a common low-pressure line 26, the low-pressure relief valve 4l, a high-pressure relief valve 4m, an accumulator 18, a pressure sensor 19, and a check valve 3g.

The common high-pressure line 25 is connected to the hydraulic pump 8a. The hydraulic fluid is supplied from the hydraulic pump 8a to the common high-pressure line 25, and pressure of the common high-pressure line 25 is maintained at a fixed level. The structure of a fixed pressure source system circuit that maintains the pressure of the common high-pressure line 25 at the fixed level is well known. As an example, in the present embodiment, a regulator 14c is arranged on the hydraulic pump 8a, the pressure sensor 19 is arranged on the common high-pressure line 25, and a detection signal of the pressure sensor 19 is input to a controller 41b. The controller 41b compares a pressure value detected by the pressure sensor 19 with a target pressure value. If the detected pressure value is lower than the target pressure value, the regulator 14c is controlled so as to increase the tilting amount (pump capacity) of the hydraulic pump 8a. If the detected pressure value is higher than the target pressure value, the regulator 14c is controlled so as to reduce the tilting amount (pump capacity) of the hydraulic pump 8a.

The common high-pressure line 25 has the relief valve 4m and the accumulator 18 connected thereto. The common low-pressure line 26 has the low-pressure relief valve 4l and the check valve 3g connected thereto. The check valve 3g is connected to the common low-pressure line 26 in parallel with the low-pressure relief valve 4l so as to allow the hydraulic fluid to flow from the tank 9 to the common low-pressure line 26.

The variable displacement type right and left travel hydraulic pump motors 13d and 13e and the variable displacement type swing hydraulic pump motor 13f are connected between the common high-pressure line 25 and the common low-pressure line 26. The variable displacement type hydraulic pump motors 13d, 13e, and 13f respectively include regulators 14e, 14f, and 14g that control tilting directions and tilting amounts.

Rotation torque of the hydraulic pump motors 13d, 13e, and 13f is represented by products of the tilting amounts (motor capacity) and the driving pressure (pressure of the common high-pressure line 25). Since the pressure of the common high-pressure line 25 is a fixed value, the rotation torque of the hydraulic pump motors 13d, 13e, and 13f can be changed by changing the tilting amounts of the hydraulic pump motors 13d, 13e, and 13f. The rotational speeds of the hydraulic pump motors 13d, 13e, and 13f can be changed by changing the rotation torque of the hydraulic pump motors 13d, 13e, and 13f. In the fixed pressure source system circuit 104, the rotational directions and rotational speeds of the hydraulic pump motors 13d, 13e, and 13f can be controlled by controlling the tilting directions and tilting amounts of the hydraulic pump motors 13d, 13e, and 13f without using a control valve.

The variable displacement hydraulic pump motors 13d, 13e, and 13f act as motors upon the driving of the loads and act as pumps upon braking. Upon the braking, the variable displacement hydraulic pump motors 13d, 13e, and 13f suck the hydraulic fluid from the tank 9 through the check valve 3g and deliver the hydraulic fluid to the common high-pressure line 25. Hydraulic energy (pressure) generated in this case is collected by the accumulator 18 and reused for acceleration of the hydraulic pump motors. Note that the accumulator 18 also has an effect of absorbing pulsation of pressure within the circuit.

Although the single fixed pressure source system circuit is arranged in the present embodiment, the number of fixed pressure source system circuits is not limited to 1 and may be 2 or more.

The controller 41b executes arithmetic processing on operation signals received from the operating devices 40a to 40d, outputs control signals after the arithmetic processing to the solenoid control valves 5a to 5i and the regulators 14a, 14b, and 14d to 14g of the hydraulic pump motors 13a to 13f of the variable displacement type, and controls these components. In addition, to maintain the pressure of the common high-pressure line 25 at the fixed level, the detection signal of the pressure sensor 19 is monitored and the regulator 14c is controlled so that the delivery pressure of the hydraulic pump 8a is fixed.

According to the present embodiment described above, the same effects of high energy saving and installability as the second embodiment and the following effects can be obtained.

In the present embodiment, since the bucket is driven by the hydraulic closed circuit 103 made up in a closed circuit manner, the energy saving is high. In addition, energy can be significantly saved by causing the fixed pressure source system circuit 104 capable of regenerating braking energy to drive the right and left travel hydraulic pump motors 13d and 13e and the swing hydraulic pump motor 13f without pressure loss caused by the control valves.

The hydraulic fluid can be mutually supplied among the three hydraulic closed circuits 100a, 101a, and 103 made up in a closed circuit manner and can be supplied from the hydraulic closed circuits 101a and 103 to the fixed pressure source system circuit 104. Thus, the hydraulic pumps can be downsized while necessary speeds of the actuators are ensured, and the installability can be improved.

If the hydraulic actuators that are driven by the fixed pressure source system circuit 104 are rotary actuators such as swing actuators or travel actuators, the rotation torque of the variable displacement hydraulic pump motors can be used without conversion, hydraulic motors that are normally used are simply replaced with the variable displacement hydraulic pump motors, and a control valve is not required. Thus, the installability is excellent.

An actuator can be easily added by arranging an additional variable displacement hydraulic pump motor between the common high-pressure line 25 and the common low-pressure line 26, and thus extensibility can be ensured.

In the present embodiment, the fixed pressure source system circuit drives the rotary actuators. However, when a hydraulic transformer in which a fixed displacement hydraulic pump motor is directly connected to a rotary shaft of a variable displacement hydraulic pump motor is used, the fixed pressure source system circuit can drive a linear actuator by causing the hydraulic fluid to be supplied from the fixed displacement hydraulic pump motor to a cap side of a hydraulic cylinder.

1. A system for driving a working machine, comprising:
a plurality of hydraulic closed circuits that connect hydraulic pumps to hydraulic actuators in a closed circuit manner;
at least one hydraulic open circuit that connects a hydraulic pump to at least one hydraulic actuator through a control valve in an open circuit manner;
a plurality of first assist circuits that connect between the plurality of hydraulic closed circuits so as to cause a hydraulic fluid to be mutually supplied between the plurality of hydraulic closed circuits; and
at least one second assist circuit that connects at least one of the plurality of hydraulic closed circuits to the hydraulic open circuit so as to cause the hydraulic fluid to be supplied from at least one of the plurality of hydraulic closed circuits to the hydraulic open circuit.

2. A system for driving a working machine, comprising:
a plurality of hydraulic closed circuits that connect hydraulic pumps to hydraulic actuators in a closed circuit manner;
at least one fixed pressure source system circuit that includes a hydraulic pump, a common high-pressure line connected to the hydraulic pump and maintaining pressure at a fixed value by receiving the hydraulic fluid delivered from the hydraulic pump, a common low-pressure line connected to a tank, an accumulator connected to the common high-pressure line, and at least one variable displacement hydraulic pump motor connected between the common high-pressure line and the common low-pressure line;
a plurality of first assist circuits that connect between the plurality of hydraulic closed circuits so as to cause a hydraulic fluid to be mutually supplied between the plurality of hydraulic closed circuits; and
at least one second assist circuit that connects at least one of the plurality of hydraulic closed circuits to the fixed pressure source system circuit so as to cause the hydraulic fluid to be supplied from at least one of the plurality of hydraulic closed circuits to the fixed pressure source system circuit.

3. The system for driving a working machine according to claim 1,
wherein the working machine is a hydraulic excavator, and
wherein the hydraulic actuators that are connected to the hydraulic pumps in a closed circuit manner in the plurality of hydraulic closed circuits are at least a boom cylinder and an arm cylinder.

4. The system for driving a working machine according to claim 2,
wherein the working machine is a hydraulic excavator, and
wherein the variable displacement hydraulic pump motor that is connected between the common high-pressure line and the common low-pressure line in the fixed pressure source system circuit is a swing hydraulic motor or a travel hydraulic motor.

5. The system for driving a working machine according to claim 2,
wherein the working machine is a hydraulic excavator, and
wherein the hydraulic actuators that are connected to the hydraulic pumps in a closed circuit manner in the plurality of hydraulic closed circuits are at least a boom cylinder and an arm cylinder.
